(19) United States
(12) Patent Application Publication
(10) Pub. No.: US 2007/0183867 A1
(43) Pub. Date: Aug. 9, 2007

(54) Joined spring washer and method of producing same

(76) Inventors: Bernfried Hesselmann, Wenden (DE); Ulrich Roth, Neunkhausen (DE); Harold Brenner, Herdorf (DE); Andreas Rinsdorf, Freudenberg (DE)

Correspondence Address: Wyatt, Gerber & O'Rourke, LLP, 99 Park Avenue, New York, NY, 10016, US

(21) Appl. No.: 11/656,107

(22) Filed: Jan. 22, 2007

(30) Foreign Application Priority Data
Jan. 26, 2006 (DE) 10 2006 003 976.9

(51) Int. Cl. F16B 43/02

(52) U.S. Cl. 411/544

(57) ABSTRACT

An axially deformable spring washer bent so as to form a ring and joined at the circumference, wherein the spring washer is provided in the form of an undulating spring with a plurality of circumferentially formed peaks and troughs, or in the form of a plate spring with a conical shape and teeth at least one circumferential edge.

### FIELD OF THE INVENTION

The present invention relates to axially deformable spring washers which have been bent to form a ring and which are joined at the circumference to form a junction. Spring washers of this type are frequently used in the form of axial play offsetting elements or axial returning elements, both as individual elements and in the form of packages comprising a plurality of spring washers. Normally, such spring washers which can be provided in the form of undulating spring rings or plate spring rings are stamped out of bar or strip material and formed into undulating spring rings or plate spring rings in subsequent production stages. This generates a large amount of scrap, including the circular piece stamped out of the ring, as well as the remaining part of the bar or strip. This results in an increase in costs due to the large amount of material required and due to the logistics of recycling the scrap material, among other things.

### BACKGROUND OF THE INVENTION

GB 1 248 473 describes how spring washers in the form of plate springs can be bent into an annular shape from flat strip material by using roller round bending devices and how they are subsequently joined to form a closed ring by being butt-joined or by producing a form-fitting engagement. A conical shape can be produced subsequently out of a flat ring after the joining operation. However, the conical shape can also be stamped when round-bending the strip material into a ring.

From U.S. Pat. No. 3,753,708 there is also known a method of producing plate springs wherein a flat strip material is used to form rings which, in the form of planar rings, are joined by means of their ends in the separating region to form a form-fitting connection.

### OBJECT OF THE INVENTION

One object of the invention is to produce a plate springs, bent in the form of a conical shape, by carrying out a thermal forming operation after the joining operation.

Another object of the present invention is to provide spring washers in the form of an undulating spring having more than one bend, which are easier to set in respect of their spring properties and which, in respect of their characteristic spring curves, can be selected more specifically than the above-described plate springs.

### SUMMARY OF THE INVENTION

A spring washer according to the invention is provided in the form of an undulating spring ring with a plurality of peaks and troughs formed around the circumference. While maintaining the advantages of production and providing a better rate of material utilization, it is possible to produce spring washers of various spring characteristics, which comprise smaller material thicknesses than prior art plate springs among other things.

According to one embodiment, a spring washer is provided in the form of an undulating spring ring with peaks and troughs with respectively different amplitudes. In this way, it is possible to produce spring washers with a bent and an increasingly progressive characteristic curve which widens the range of application of the inventive spring washers.

According to a further embodiment, a spring washer according to the invention is provided in the form of an undulating spring ring with a conical basic shape with a superimposed undulating shape. Such springs combine a good reaction behaviour with a somewhat steeper characteristic spring curve without the thickness of the material having to be increased.

For subsequent treatments and in respect of the load on the junction, it is advantageous if the junction is produced on a peak or in a trough portion.

According to another embodiment, a spring washer according to the invention is provided in the form of a plate spring with slots or teeth on at least one of the inner and outer circumferences. Thus, it is possible to produce spring washers which, while retaining the same spring forces, can achieve a greater stroke than unslotted plate springs while retaining the aforementioned production advantages.

According to another embodiment, a spring washer according to the invention is provided wherein the teeth are widened radially from the base to the crown. Alternatively, or in addition, the teeth can be widened from the crown to the base. Alternatively, or in addition, the teeth can comprise the conventional rectangular shape or saw tooth shape.

To compensate for any potential weakening caused by the junction, another embodiment of a spring washer according to the invention is provided wherein the ring is relatively wider in the junction and in the region opposite the junction. By widening the ring twice, the finished ring is prevented from behaving asymmetrically.

A particularly advantageous stress distribution in the spring washer can be achieved if a cross-sectional shape whose material thickness decreases from the outside to the inside is provided.

A method of producing the spring washers according to the invention is provided wherein the spring washer is formed into an undulating spring ring after having been joined, with the spring washer, being hot-formed in a die. According to a further inventive method of producing spring washers of another embodiment, the spring washer is provided with teeth or slots on the inner or outer circumference after having been joined, with the teeth or slots being produced by punching or precision cutting. Unless the spring washer has already been formed into a cone during the round bending operation, the cone can be produced by hot-forming in a die after the completion of the ring joining operation.

The method according to the invention can be carried out in such a way that the spring washer is welded in the junction, and can be subsequently ground in order to remove any welding bead. In addition, or in the alternative, the spring washer ends can be provided with positive, form-fitting engagement means when being separated from the continuous strip which form-fitting engagement means can be subsequently engaged with one another and stamped.

In a further method of producing spring washers according to the invention, cross-sectional shapes with a non-constant material thickness can be provided by rolling strip material in advance of the round bending operation.

### BRIEF DESCRIPTION OF THE DRAWINGS

Several embodiments of the invention are illustrated in the drawings and are described below.

FIG. 1 illustrates a plan view of a device for producing spring washers, according to the invention, out of strip material.

FIG. 2a illustrates a portion of two embodiments of a joined spring washer according to the invention with a welded junction.

FIG. 2b illustrates a portion of two embodiments of a joined spring washer according to the invention with a positively and form-fittingly pressed junction.

FIG. 3a illustrates an embodiment of an undulating spring according to the invention with peaks and roughs with identical amplitude.

FIG. 3b illustrates an embodiment of an undulating spring according to the invention with peaks and troughs with different amplitudes.

FIG. 4a illustrates an embodiment of a spring washer according to the invention having inner teeth with radially inwardly widening teeth.

FIG. 4b illustrates an embodiment of a spring washer according to the invention having inner teeth with radially inwardly tapered teeth.

FIG. 5a illustrates an embodiment of a spring washer according to the invention having radially outer teeth with two widened regions arranged radially opposite one another.

FIG. 5b illustrates an embodiment of a spring washer according to the invention having radially outer teeth with circumferentially uniform teeth.

### DETAILED DESCRIPTION

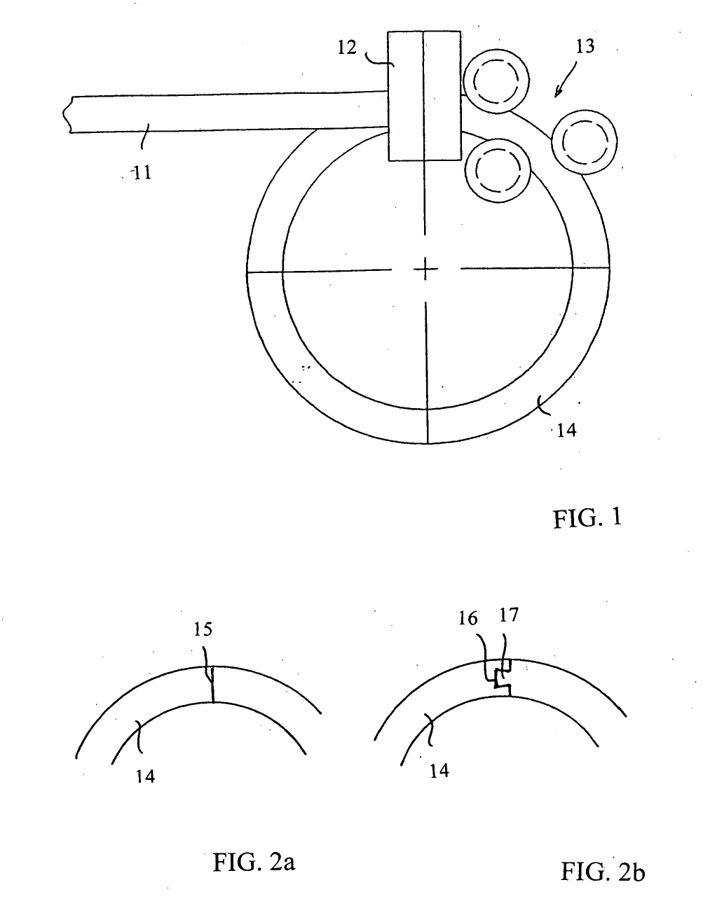

FIG. 1 shows a strip forming device 10 for bending spring washers, according to the invention. In FIG. 1, an extended flat strip 11 is shown which, via a roller guide 12, runs into a three-roll bending assembly 13 in which the strip is bent to form a ring 14. As soon as a complete ring 14 of approximately 360° has been produced, a complete ring 14 with an open junction can be separated in a separating device underneath the roller guide 12. This process can be repeated continuously with a continuous feed of the strip 11, with little or no scrap being produced between the individual annular portions. The individual annular portions can be separated in such a way that a junction 15 can be created which can be used to join ends of the annular portions. Thus, a planar flat ring 14 can be formed in the three roller bending assembly. In addition, the ring 14 can be provided with a range of conical shapes according to the bending operation, such as if the ring is to be formed as a plate spring at a later stage.

The continuous strip 11 can be a split strip produced from an originally wider rolled strip or it can be produced from a flat-rolled wire. The thickness/width ratio of the strip 11 can be provided to correspond to that of the finished product, i.e. of the bent and joined spring washer. The spring washer can also be produced from a cross-section deviating from the rectangular cross-section. Such a cross-section can be produced by a rolling operation carried out on a strip material while in the extended condition.

The junctions 15 of the individual separated rings 14 can be joined in different ways.

FIG. 2 shows two examples of a method for joining the ends of the ring 14. FIG. 2a shows the ring 14 with the junction in the form of a straight abutment 15 which has can be joined by a material-locking connection or by a welding operation. Other suitable welding methods can be used such as laser welding. For removing welding beads, the welded spot can be subsequently ground.

In FIG. 2b, a ring 14 according to the invention is shown comprising a junction with a positive, form-engaging connection, a recess 16 provided at one end of the ring, and a corresponding tab 17 provided at the other end of the ring. The form-engaging connections can be provided in the circumferential direction, such as being provided with an undercut, so that the form-engaging connection can accommodate circumferential forces without any need for further measures. The junction can be closed by stamping the ring ends, which can take place simultaneously with the operation of forming the ring into a conical shape. There may not be any need for an additional welding operation.

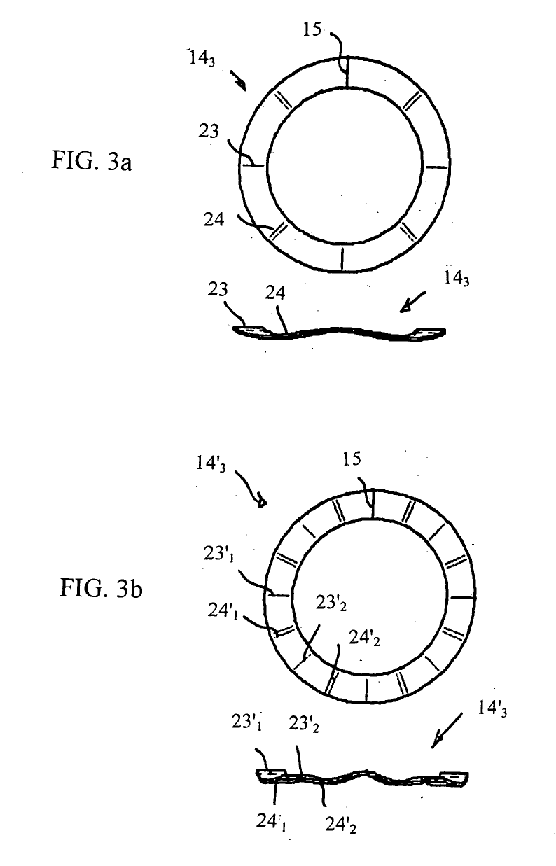

FIG. 3 shows a plan view and a cross-sectional view, two embodiments of undulating washers, 14₃, 14′₃, according to the invention in which the junction 15 is provided in the form of an abutment. Furthermore, single radial lines indicate peaks 23 and double radial lines indicate troughs 24. In the embodiment according to FIG. 3a, the amplitudes of the peaks 23′₁, 23′₂ and of the troughs 24′₁, 24′₂ can be identical, whereas in the embodiment according to FIG. 3b peaks 23′ and troughs 24′ can uniformly alternate around the circumference with different amplitudes. The undulating washers can be produced by deforming planar joined spring washers in a die, such as by hot deformation. In each case, the junction 15 can be positioned in a peak and forms a straight abutment.

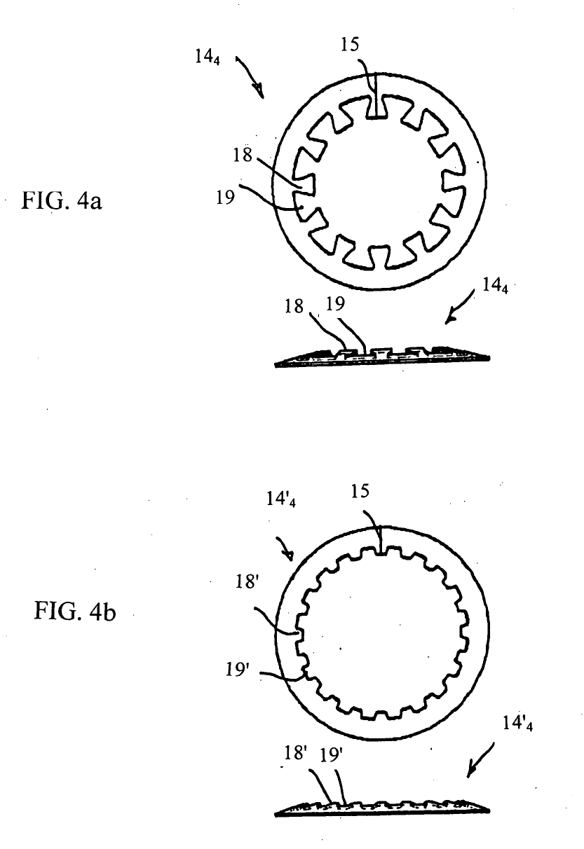

FIG. 4 shows a plan view and a cross-sectional view, wherein spring washers 14₄, 14′₄ according to the invention are provided wherein the junction 15 is shown to be a straight abutment. The spring washers can be provided with a conical shape and comprise inner radial teeth 18 with intermediate gaps 19. As shown in FIG. 4a, the teeth 18 can be provided to increase in width from the base to the crown, whereas in FIG. 4b, the teeth 18′ can be provided to decrease in width from the base to the crown. Alternatively, or in addition, the teeth can be provided with width that is nearly constant.

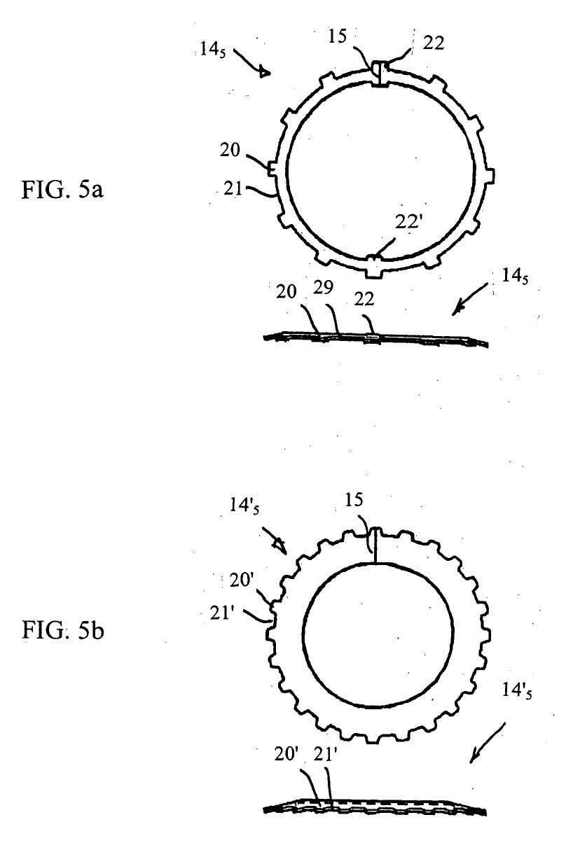

FIG. 5 shows a plan view and a cross-sectional view, wherein spring washers 14₅, 14₅, according to the invention are provided being conical in shape, and comprising outwardly directed teeth 20 with intermediate gaps 21. The junction 15 is shown in the form of a straight abutment. In FIG. 5a, a widened washer portion 22, 22′ is provided in the region of the junction and radially opposed thereto. In FIG. 5b, the shape of the washer is substantially uniform around the circumference, i.e. the teeth 20′ and the slots 21′ can comprise identical shapes relative to one another. The widened washer portion 22 serves to extend the junction 15, whereas the widened washer portion 22′ is provided to avoid out-of-balance characteristics.

We claim:

1. A spring washer comprising:
a strip material and a junction,
wherein strip material is substantially ring-shaped and further comprises a plurality of peaks and troughs arranged around a circumference of the strip material.

2. The spring washer according to claim 1, wherein the plurality of peaks and troughs include at least a first set of peaks and troughs, and a second set of peaks and troughs, wherein the first set of peaks and troughs have a first amplitude, and the second set of peaks and troughs have a second amplitude, and wherein the first amplitude differs from the second amplitude.

3. The spring washer according to claim 1, wherein the strip material has a conical shape in the radial direction, and wherein the conical shape is superimposed over the plurality of peaks and troughs.

4. The spring washer according to claim 1, wherein the junction is arranged on a peak.

5. The spring washer according to claim 1, wherein the junction is arranged in a trough.

6. The spring washer according to claim 1, wherein the strip material further comprises at least two wider portions, said at least two wider portions being provided at least at the junction and at a location radially opposite the junction.

7. A spring washer comprising:
a strip material and a junction,
wherein the strip material is substantially ring-shaped and is joined at the junction, and
wherein the strip material further comprises a plurality of teeth and slots arranged on at least one of the inner and outer circumferential edges of the strip material.

8. A spring washer according to claim 7, wherein at least a portion of the plurality teeth are rectangular in shape.

9. A spring washer according to claim 7, wherein at least a portion of the plurality teeth are saw tooth in shape.

10. The spring washer according to claim 7, wherein at least a portion of the plurality of the teeth widen radially from the base to the crown.

11. The spring washer according to claim 7, wherein at least a portion of the plurality of the teeth widen radially from the crown to the base.

12. The spring washer according to claim 7, wherein the strip material further comprises at least two wider portions, said at least two wider portions being provided at least at the junction and at a location radially opposite the junction.

13. The spring washer according to claim 7, wherein the junction further comprises a weld.

14. The spring washer according to claim 7, wherein the junction further comprises a pressed form-engaging connection.

15. The spring washer according to claim 14, wherein the form-engaging connection includes an undercut in the circumferential direction.

16. The spring washer according to claim 7, wherein the junction is arranged on one of the plurality of teeth and slots.

17. The spring washer according to claim 7, wherein the strip material has a conical shape in the radial direction, and wherein the conical shape is superimposed over the plurality of peaks and troughs.

18. A method of producing a spring washer, comprising the steps of:
bending a strip material into a ring-shaped portion of the strip material,
further bending the strip material to provide a plurality of peaks and troughs arranged around a circumference of the strip material, and
joining the two ends of the ring-shaped portion of the strip material to form an undulating ring.

19. The method according to claim 18, wherein the step of bending includes a step of hot-forming.

20. The method according to claim 18, further comprising providing the ring with radial teeth after the joining step.

21. The method according to claim 18, further comprising providing the ring with radial slots after the joining step.

22. The method according to claim 21, further comprising a step of further bending the ring into the shape of a cone after the joining step, wherein the further bending step includes hot-forming.

23. The method according to claim 21, further comprising a step of further bending the ring into the shape of a cone after the bending step, wherein the further bending step includes hot-forming.

24. The method according to claim 18, further comprising welding at the junction.

25. The method according to claim 18, further comprising stamping the two ends of the ring-shaped portion of the strip material, thereby providing the two ends with a positive, form-fitting engagement.

26. The method according to claim 18, further comprising heat treating the undulating ring after the joining step.

27. The method according to claim 18, wherein the step of further bending include arranging at least one of the plurality of peaks and troughs at the junction.

28. The method according to claim 16, wherein the further bending includes passing the strip material through a roller assembly having at least three rollers, wherein at least two of the at least three rollers are disposed on one side of the strip material and at least one of the at least three rollers is disposed on an opposite side and substantially in between the at least two of the three rollers, whereby the at least three rollers cooperate in the bending of the strip material to form undulations in the ring.
